(19) United States
(12) Patent Application Publication
(10) Pub. No.: US 2012/0209729 A1
(43) Pub. Date: Aug. 16, 2012

(54) Business communication system and method

(76) Inventor: Kenneth J. Lovegreen, Lake Kiowa, TX (US)

(21) Appl. No.: 12/931,819

(22) Filed: Feb. 11, 2011

(51) Int. Cl. G06Q 50/00; G06Q 30/00

(52) U.S. Cl. 705/15; 705/26.1

(57) ABSTRACT

A system and method for enabling a customer with a mobile telecomputing device such as a smart phone to communicate with a waiter in a restaurant. The smart phone connects to a wireless local area network such as a WiFi network within the restaurant and, in a first embodiment, downloads a restaurant communication application. The communication application associates buttons on the smart phone with requests for different services in the restaurant. When the customer presses a button, a computer controlling the WiFi network routes an indication of the customer's table number and requested service to the waiter via an on-premises paging system or via a text message to the waiter's mobile phone. In a second embodiment, the smart phone is directed to a website providing a restaurant communication service. The service request buttons are displayed on a webpage, and customer selections are routed to the waiter as before.

### BACKGROUND

1. Technical Field

This invention relates to communication systems and, more particularly, to a wireless communication system and method enabling a customer in a restaurant or other business establishment to communicate with a waiter or other service person.

2. Description of Related Art

In some restaurants today, customers can push a button on a transmitter mounted on their table to request service from their waiter. The transmitter may be programmed to transmit a table number to a control PC, or to transmit an identifier that is then associated with a table number by the PC. The PC may also include a list of waiters assigned to each table number and a lookup table for identifying corresponding pager numbers for the waiters. An on-premises paging transmitter then pages the correct waiter to respond to the customer's request for service.

The mounted transmitters, however, have the disadvantage that the restaurant staff must maintain and, if necessary, repair them. Batteries must be regularly replaced, and the transmitters are susceptible to damage by customers.

It would be advantageous, therefore, to have a restaurant communication system and method enabling a customer to communicate with a waiter while eliminating the need for the restaurant staff to maintain or repair transmitters mounted on the tables. The present invention provides such a system and method.

### SUMMARY OF THE INVENTION

In one embodiment, the present invention is directed to a method of enabling a customer with a mobile telecomputing device to communicate with a waiter in a restaurant. The method includes the steps of connecting the mobile telecomputing device to a wireless local area network within the restaurant; downloading to the mobile telecomputing device, a communication application program; and associating by the downloaded communication application program, a button on the mobile telecomputing device with a request for service in the restaurant. The method also includes receiving by a computer controlling the wireless local area network, an indication that the customer pressed the button; and routing the indication from the computer to a communication device carried by the waiter.

In another embodiment, the present invention is directed to a system for enabling a customer with a mobile telecomputing device to communicate with a waiter in a restaurant. The system includes a wireless local area network within the restaurant for communicating with the mobile telecomputing device; means for downloading to the mobile telecomputing device, a communication application program, wherein the downloaded communication application program associates a button on the mobile telecomputing device with a request for service in the restaurant; and a computer connected to the wireless local area network. The computer includes means for controlling the wireless local area network; and means for receiving an input from the wireless local area network indicating the customer pressed the button. The system also includes means for routing the indication from the computer to a communication device carried by the waiter.

In another embodiment, the present invention is directed to a method of enabling a customer with a mobile telecomputing device to communicate with a waiter in a restaurant. The method includes the steps of connecting the mobile telecomputing device to a wireless local area network within the restaurant; registering the mobile telecomputing device by a registration application program executed by a computer controlling the wireless local area network; and connecting the mobile telecomputing device through an Internet connection to an application server at a website providing a restaurant communication service. The method also includes presenting on a display of the mobile telecomputing device, a webpage showing a button associated with a request for service in the restaurant; detecting that the customer pressed the button; and routing an indication that the customer pressed the button from the computer controlling the wireless local area network to a communication device carried by the waiter.

In another embodiment, the present invention is directed to a system for enabling a customer with a mobile telecomputing device to communicate with a waiter in a restaurant. The system includes a wireless local area network within the restaurant for communicating with the mobile telecomputing device; a registration application program executed by a computer controlling the wireless local area network for registering the mobile telecomputing device; and an Internet connection for connecting the mobile telecomputing device to an application server at a website providing a restaurant communication service. The system also includes means for presenting on a display of the mobile telecomputing device, a webpage showing a button associated with a request for service in the restaurant; means for detecting that the customer pressed the button; and means for routing an indication that the customer pressed the button from the computer controlling the wireless local area network to a communication device carried by the waiter.

In another embodiment, the present invention is directed to a server remotely located from a business establishment for facilitating the business establishment to serve a customer. The server includes a processor for controlling the operation of the server; and incoming communication means for receiving a service-request message from the customer sent via a public wireless communication network, wherein the service-request message is a text message including a business establishment identifier and a location identifier for the customer's location in an area of responsibility for the business establishment. The server also includes a first database for mapping business establishment identifiers with business establishments, wherein the server utilizes the first database to identify the business establishment; a second database for mapping location identifiers with service personnel, wherein the server utilizes the second database to identify a service person at the identified business establishment assigned to serve the customer's location; and outgoing communication means for notifying the identified service person that service is requested at the customer's location.

In another embodiment, the present invention is directed to a system for facilitating a business establishment to serve a customer. The system includes a backend server and a computer associated with the identified business establishment. The backend server includes a processor for controlling the operation of the server; and incoming communication means for receiving a service-request message from the customer sent via a public wireless communication network, wherein the service-request message is a text message including a business establishment identifier and a location identifier for the customer's location in an area of responsibility for the business establishment. The backend server also includes a first database for mapping business establishment identifiers with business establishments, wherein the server utilizes the first database to identify the business establishment; and outgoing communication means for sending a notification to the identified business establishment that service is requested at the received location identifier. The computer associated with the identified business establishment includes a processor for controlling the operation of the computer; incoming communication means for receiving the notification from the backend server; and a second database for mapping location identifiers with service personnel, wherein the server utilizes the second database to identify a service person at the identified business establishment assigned to serve the customer's location. The computer also includes outgoing communication means for notifying the identified service person that service is requested at the customer's location.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a first exemplary embodiment of the system of the present invention;

FIG. 2 is a flow chart illustrating the steps of a first exemplary embodiment of the method of the present invention;

FIG. 3 is a simplified block diagram of a second exemplary embodiment of the system of the present invention;

FIG. 4 is a flow chart illustrating the steps of a second exemplary embodiment of the method of the present invention;

FIG. 5 is a simplified block diagram of a third and a fourth exemplary embodiment of the system of the present invention;

FIG. 6 is a flow chart illustrating the steps of the third exemplary embodiment of the method of the present invention; and

FIG. 7 is a flow chart illustrating the steps of the fourth exemplary embodiment of the method of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention. The invention may be implemented in hardware or in a combination of hardware and software. For example, one or more computers or processors may perform the steps of the method of the present invention when executing computer program instructions stored in one or more program memories. Additionally, individual components of the invention may include their own processor and memory for controlling their functions.

The present invention provides a solution in which the customer's mobile phone is used as a restaurant communication device. Large numbers of customers now carry personal computing devices such as Personal Digital Assistants (PDAs) or “smart phones”, which are highly capable processing and communication devices. Smart phones can access both the cellular telephone network referred to as the Public Land Mobile Network (PLMN) through radio base stations as well as Local Area Networks (LANs) through unlicensed radio access networks utilizing WiFi or Wireless LAN (WLAN) technology. In addition to voice calls, smart phones can send text messages, e-mails, and can access the Internet and worldwide web.

The invention is described herein in terms of a customer's smart phone although the invention is applicable to any type of mobile computing device capable of making a WiFi connection and communicating through the WiFi connection. These devices may be referred to generically as mobile telecomputing devices. The present invention takes advantage of these capabilities of mobile telecomputing devices.

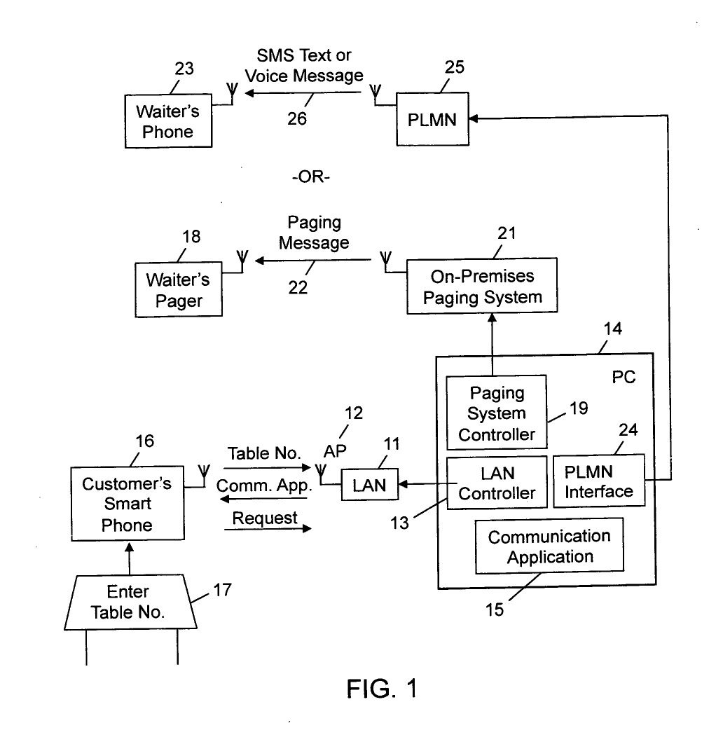

FIG. 1 is a simplified block diagram of a first exemplary embodiment of the system of the present invention. In this embodiment, a WiFi Local Area Network (LAN) 11 is set up with at least one access point (AP) 12 inside the restaurant. The network may be controlled, for example, by a LAN controller 13 in a PC 14 in a back office of the restaurant. The customer is provided with a table number and instructions for downloading a restaurant communication application 15 to the customer's smart phone 16. This information may be provided by a sign at each table or may be provided to the customer by a hostess or the waiter. The customer follows the instructions and connects to the WiFi network and downloads the application to the customer's smart phone.

The application gathers data from the back office PC to define the functions of various buttons displayed to the customer on the phone's touch-screen display, or present on the phone's keyboard. When prompted by the application, the customer enters the table number 17. The customer can then use the smart phone to communicate with the waiter as further described below.

In an example scenario, a first button may be used to request a drink; another button may be used to request the customer's check; and another button may enable the customer to enter a text message with specific instructions for the waiter. When the customer presses one of the defined buttons, the communication application on the customer's phone sends a corresponding indication and the table number over the WiFi network 11 to the back office PC 14, which also controls communications with the waiter. In one embodiment, the waiter carries an on-premises pager 18, and a paging system controller 19 in the back office PC controls an on-premises paging system 21. The PC matches the table number with the waiter who is responsible for that table, and sends a command to the on-premises paging transmitter to send a paging message 22 to the waiter with the customer's table number and request. In an alternative embodiment, if the restaurant does not have an on-premises paging system, the waiter may carry a mobile phone 23 instead. In this embodiment, the back office PC includes a PLMN interface 24, which may place a call to the waiter's phone through the PLMN 25 with a recorded voice message or a Short Message Service (SMS) text message 26 indicating the table number and the customer's request. The waiter then responds to the customer's request.

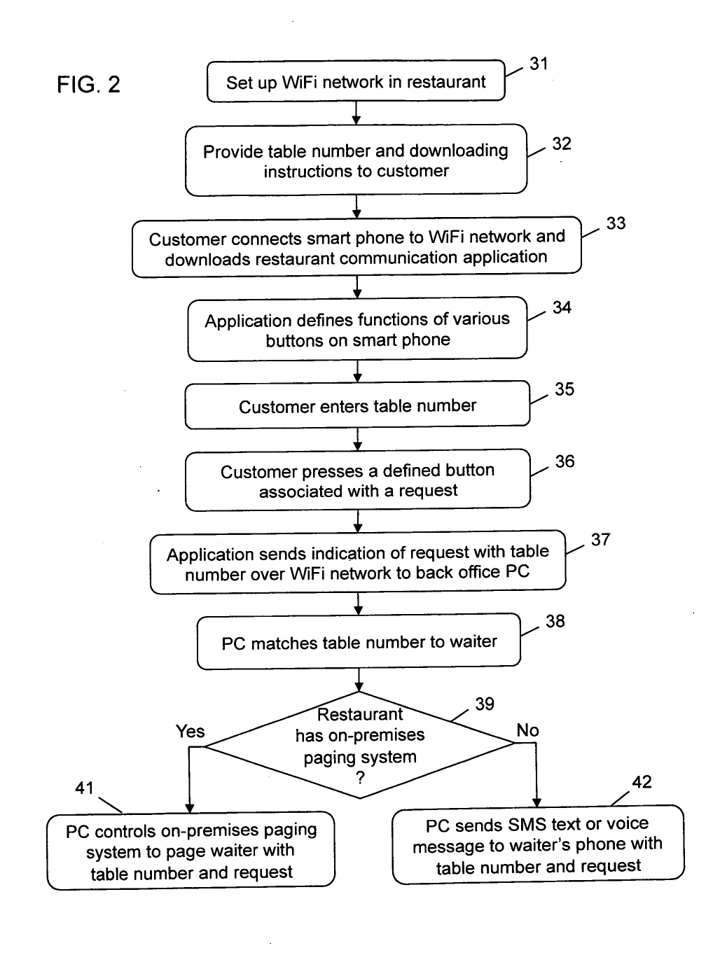

FIG. 2 is a flow chart illustrating the steps of a first exemplary embodiment of the method of the present invention. At step 31, the WiFi network 11 is set up in the restaurant. At step 32, the table number and application-downloading instructions are provided to the customer. At step 33, the customer connects the smart phone 16 to the WiFi network and downloads the restaurant communication application 15. At step 34, the communication application defines the functions of various buttons on the smart phone. At step 35, the customer enters the table number.

At a later time indicated in step 36, the customer presses a defined button on the smart phone 16 associated with a request. At step 37, the communication application downloaded to the phone sends an indication of the request with the table number over the WiFi network to the back office PC 14. At step 38, the PC matches the table number to the waiter. At step 39, it is determined whether the restaurant has an on-premises paging system. If so, the method moves to step 41 where the PC controls the on-premises paging system to page the waiter with the table number and request. If the restaurant does not have an on-premises paging system, the method moves to step 42 where the PC sends either an SMS text message or a recorded voice message to the waiter with the table number and request.

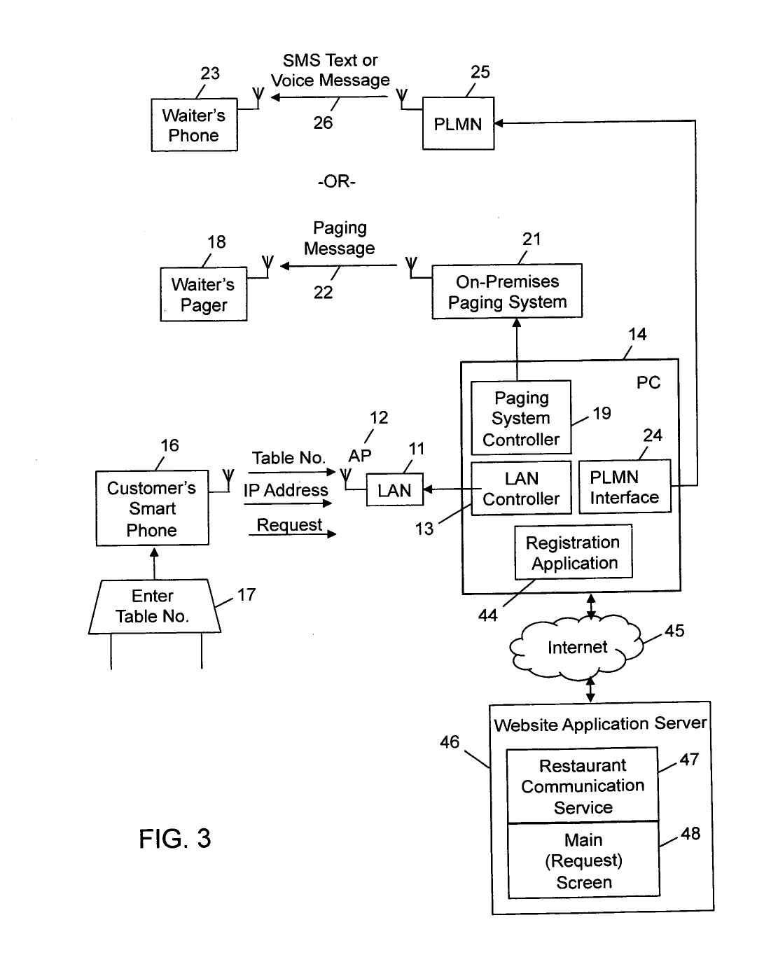

FIG. 3 is a simplified block diagram of a second exemplary embodiment of the system of the present invention. In this embodiment, the customer's smart phone 16 is registered (for example by registering the smart phone's IP address) with a registration application 44 running on the back office control PC 14. This may be done when the customer is seated and logs onto the WiFi network 11. Likewise, the customer's phone is deregistered when the customer leaves the restaurant or the signal is otherwise lost or falls below a threshold signal strength level. When the customer accesses the WiFi network, the registration application directs the smart phone 16 over the Internet 45 to a website with an application server 46 providing a restaurant communication service 47. The customer can click on “Normal view” or “Mobile View” but cannot surf through this website; it is dedicated to providing service buttons only. The website may request the customer's table number, or the number may be obtained and provided to the website by the back office application. If provided by the customer, the website may display, for example, a message such as, “Please enter your table number found on the sign on your table.” The customer enters the table number and is then directed to another webpage (Main Screen) 48 that may simply display a number of request buttons with labels such as Check, Drink Refill, Service, Ketchup, and the like. Definitions of the buttons are configurable by the restaurant management.

When the customer presses a button, the screen may momentarily display a message such as, “Your request is being processed”. The screen then returns to the Main Screen of buttons. The website application server 46 sends the customer selection and table number to the back office PC 14, which delivers the message to the appropriate waiter as described above using either the on-premises paging system 22 or the PLMN 25. The waiter then responds to the customer's request.

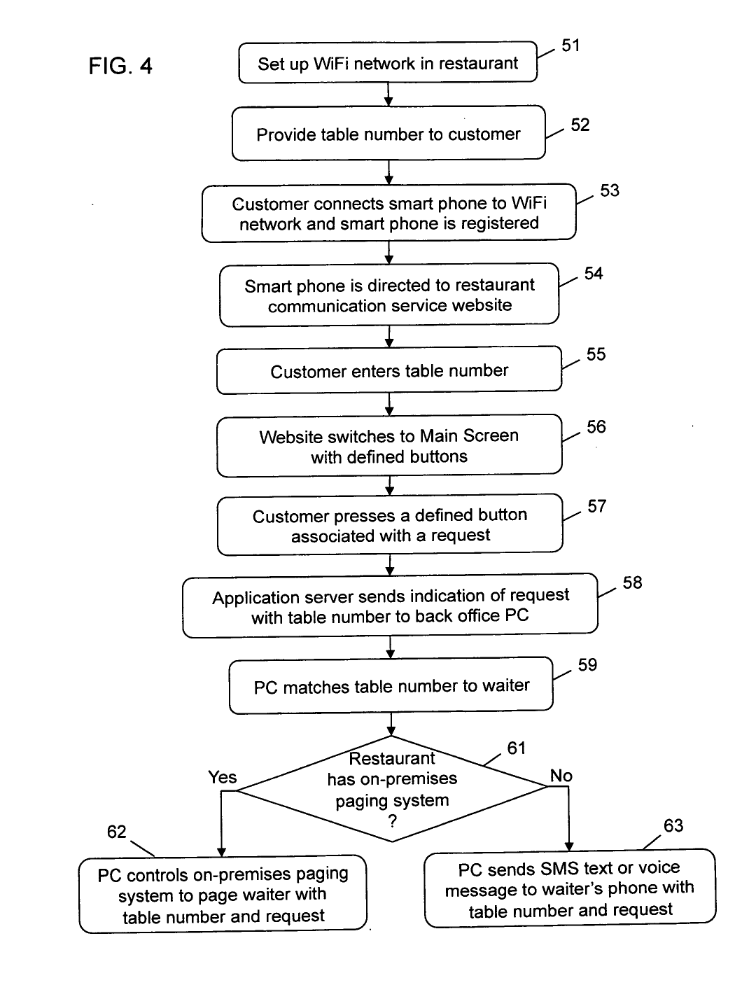

FIG. 4 is a flow chart illustrating the steps of a second exemplary embodiment of the method of the present invention. At step 51, the WiFi network 11 is set up in the restaurant. At step 52, the table number is provided to the customer. At step 53, the customer connects the smart phone 16 to the WiFi network and the registration application 44 registers the smart phone. At step 54, the registration application directs the phone to the restaurant communication website 46. At step 55, the customer enters the table number.

At step 56, the website switches to the Main Screen of defined request buttons, which appear on the touch screen display of the smart phone 16. At a later time indicated in step 57, the customer presses a defined button on the smart phone associated with a request. At step 58, the application server sends an indication of the request with the table number to the back office PC 14. At step 59, the PC matches the table number to the waiter. At step 61, it is determined whether the restaurant has an on-premises paging system. If so, the method moves to step 62 where the PC controls the on-premises paging system to page the waiter with the table number and request. If the restaurant does not have an on-premises paging system, the method moves to step 63 where the PC sends either an SMS text message or a recorded voice message to the waiter with the table number and request.

An advantage of the second embodiment is that it is more resistant to spoofing by former customers or other individuals who log onto the WiFi network from outside the restaurant in order to send bogus messages to waiters inside. The registration application only allows on-premises access to the restaurant communication website and blocks outside access attempts. The registration application may decode any requests destined for the website and grant access to the website only if the calling phone is currently registered with the application. If so, the application determines which waiter is responsible for that table and pages the appropriate waiter.

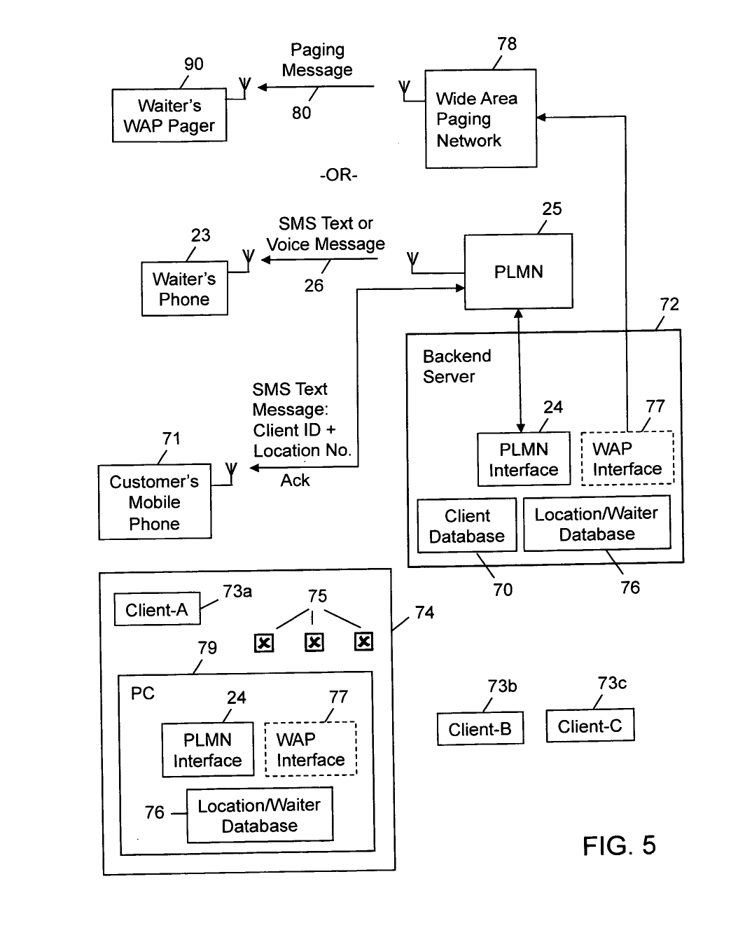

FIG. 5 is a simplified block diagram of a third and a fourth exemplary embodiment of the system of the present invention. This embodiment addresses the scenario in which there is no WiFi network available to the customer, but the customer has access to the PLMN 25 using a mobile communication device such as a cellular phone 71. In this embodiment, a backend server 72 may service a number of different clients 73a-73c which may be, for example, different companies, hotels, restaurants, or the like. Each client, such as client 73a, may have a domain of responsibility 74 where the client's customers are located. A number of locations 75 within the domain of responsibility are assigned identification numbers, and a service person is assigned to serve customers at various locations. The backend server maintains a location/waiter database 76 of location numbers and associated service persons such as waiters. In the case of a restaurant, the domain of responsibility may be the dining room, the locations may be dining tables, and the service persons may be waiters serving customers in the dining room. For a hotel, the domain of responsibility may include an area on the hotel beach, the locations may be beach umbrellas or beach chairs, and the service persons may be waiters assigned to serve food and/or beverages in locations other than the hotel restaurant. The backend server 72 also includes a PLMN interface 24 and optionally a wide area paging (WAP) network interface 77 for communicating over a wide area paging network 78. In an alternative embodiment described below, a PC 79 implemented at each of the client's location includes the database 76, the PLMN interface 24, and optionally the wide area paging network interface 77.

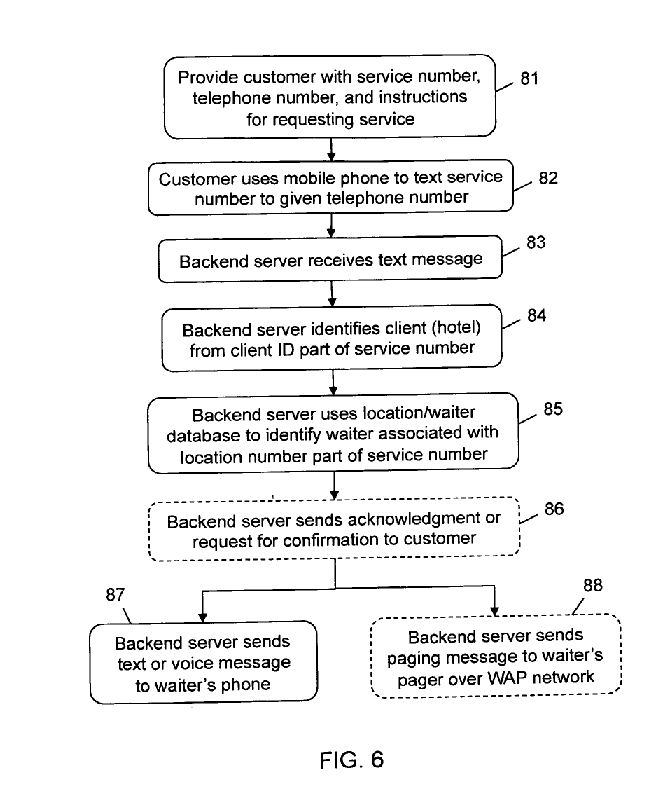

FIG. 6 is a flow chart illustrating the steps of a third exemplary embodiment of the method of the present invention. This embodiment uses text messages such as the Short Messaging Service (SMS) over the PLMN 25 when there is no Wi-Fi network available to the customer. For illustrative purposes, a customer such as a guest at a hotel is presumed to be on the hotel beach away from a restaurant or bar. At step 81, the customer is provided with a service number and a telephone number (or short code) and instructions to text the service number to the telephone number (or short code) if the customer needs service. The service number may include a first part representing a client identifier (company, hotel, restaurant, or the like) and a second part representing a location number within the domain of responsibility of the identified company, hotel, or restaurant. For example, a sign on the customer's beach umbrella or chair may state, “If you would like service, please TEXT 349567221 to 82538 (“VALET”).” In this example, the numbers 349567 represent an identifier for the hotel. The numbers 221 represent the particular beach umbrella or chair within that hotel's domain where the customer is seated. The numbers 82538 are an SMS short code.

A short code (or short number) is a dialed number that is shorter than a regular telephone number and is used to address SMS messages. Some short codes are unique to a given operator while others are shared. In some countries, short codes are also shared. If a shared short code is utilized, the customer may be requested to first text a word such as “WAITER” (or similar) to the shared short code. If the customer service is being provided by Operator-A, it can then be determined that Operator-A gets credit for this call. The call may then be routed to the backend server 72. The backend server sends a message back to the customer requesting the customer to enter the service number, which identifies the business establishment and location within that establishment's domain of responsibility. The waiter associated with that location is then notified that the customer needs service. This is explained in more detail below.

At step 82, the customer needs service and uses his cellular phone 71 to text the service number to the given phone number. The message is routed through the PLMN 25 to the backend server 72. At step 83, the backend server receives the text message. At step 84, the backend server uses a client database 70 to identify the client (in this case the customer's hotel) from the client identifier part of the service number (e.g., 349567). At step 85, the backend server uses the location/waiter database 76 to identify a waiter associated with the location number part of the service number (e.g., 221). At step 86, the backend server may optionally send a message back to the customer acknowledging the service request or requesting the customer to confirm that a waiter is needed. At step 87, the backend server may then send a text message or voice message 26 through the PLMN 25 to the identified waiter's phone 23 notifying the waiter that the customer at the identified location needs service. At step 88, the backend server may optionally send this notification as a paging message 80 to the identified waiter's wide area pager 90 over the wide area paging network 78.

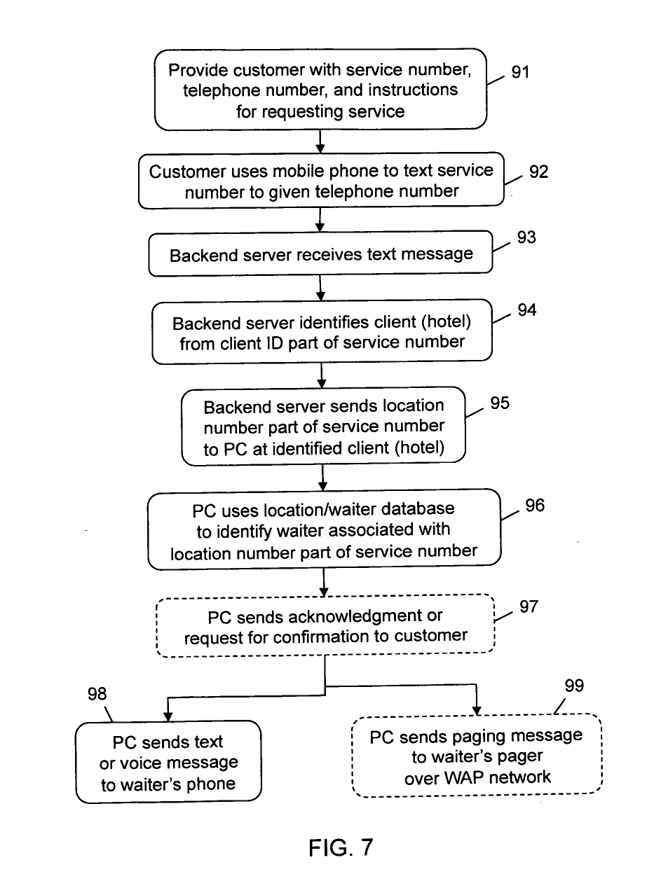

FIG. 7 is a flow chart illustrating the steps of a fourth exemplary embodiment of the method of the present invention. In this alternative embodiment, the database 76 of location numbers and associated service persons is implemented in a PC 79 located at each client's location. The PC also includes a PLMN interface 24 and optionally a wide area paging (WAP) network interface 77.

At step 91, the customer is provided with the service number and the telephone number and instructions to text the service number to the telephone number if the customer needs service. At step 92, the customer needs service and uses his cellular phone 71 to text the service number to the given phone number. The message is routed through the PLMN 25 to the backend server 72. At step 93, the backend server receives the text message. At step 94, the backend server uses the client database 70 to identify the client (in this case the customer's hotel) from the client identifier part of the service number (e.g., 349567). At step 95, based on configurable messaging options set up for the hotel, the backend server may send a message with the location number to the PC 79 at the proper hotel. At step 96, the PC access the location/waiter database 76 to determine the proper waiter/pager number associated with beach umbrella or chair number 221. At step 97, the PC may optionally send a message back to the customer acknowledging the service request or requesting the customer to confirm that a waiter is needed. At step 98, the PC then sends a text or voice message to the waiter with “SERVICE 221”. At step 99, the PC may optionally send this notification as a paging message to the identified waiter's wide area pager over the wide area paging network 78.

It is thus believed that the operation and construction of the present invention will be apparent from the foregoing description. While the system and apparatus shown and described has been characterized as being preferred, it will be readily apparent that various changes and modifications could be made therein without departing from the scope of the invention as defined in the following claims.

What is claimed is:

1. A method of enabling a customer with a mobile telecomputing device to communicate with a waiter in a restaurant, the method comprising the steps of:
connecting the mobile telecomputing device to a wireless local area network within the restaurant;
downloading to the mobile telecomputing device, a communication application program;
associating by the downloaded communication application program, a button on the mobile telecomputing device with a request for service in the restaurant;
receiving by a computer controlling the wireless local area network, an indication that the customer pressed the button; and
routing the indication from the computer to a communication device carried by the waiter.

2. The method according to claim 1, further comprising:
associating a plurality of buttons on the mobile telecomputing device with requests for a plurality of services; and
wherein the step of receiving the indication includes receiving an input that identifies a table number of the customer and which service was requested.

3. The method according to claim 1, wherein the waiter carries a pager and the step of routing the indication includes:
sending the indication from the computer to an on-premises paging system; and
transmitting the indication by the on-premises paging system to the waiter's pager.

4. The method according to claim 1, wherein the waiter carries a mobile phone and the step of routing the indication includes:
sending the indication from the computer to a public radio telecommunication network; and
transmitting the indication by the public radio telecommunication network to the waiter's mobile phone.

5. The method according to claim 4, wherein the step of transmitting the indication by the public radio telecommunication network to the waiter's mobile phone includes sending a text message to the waiter's mobile phone indicating a table number of the customer and a requested service.

6. The method according to claim 4, wherein the step of transmitting the indication by the public radio telecommunication network to the waiter's mobile phone includes sending a recorded voice message to the waiter's mobile phone indicating a table number of the customer and a requested service.

7. A system for enabling a customer with a mobile telecomputing device to communicate with a waiter in a restaurant, the system comprising:
at least one processor for controlling operation of the system;
a wireless local area network within the restaurant for communicating with the mobile telecomputing device;
means for downloading to the mobile telecomputing device, a communication application program, wherein the downloaded communication application program associates a button on the mobile telecomputing device with a request for service in the restaurant;
a computer connected to the wireless local area network, the computer including:
means for controlling the wireless local area network; and
means for receiving an input from the wireless local area network indicating the customer pressed the button; and
means for routing the indication from the computer to a communication device carried by the waiter.

8. The system according to claim 7, wherein the waiter carries a pager and the means for routing the indication to a communication device carried by the waiter includes:
means for sending the indication from the computer to an on-premises paging system; and
an on-premises paging transmitter for transmitting the indication to the waiter's pager.

9. The system according to claim 7, wherein the waiter carries a mobile phone and the means for routing the indication to a communication device carried by the waiter includes:
means for sending the indication from the computer to a public radio telecommunication network; and
means for transmitting the indication by the public radio telecommunication network to the waiter's mobile phone.

10. The system according to claim 9, wherein the means for transmitting the indication by the public radio telecommunication network to the waiter's mobile phone includes means for sending a text message to the waiter's mobile phone indicating a table number of the customer and a requested service.

11. The system according to claim 9, wherein the means for transmitting the indication by the public radio telecommunication network to the waiter's mobile phone includes means for sending a recorded voice message to the waiter's mobile phone indicating a table number of the customer and a requested service.

12. A method of enabling a customer with a mobile telecomputing device to communicate with a waiter in a restaurant, the method comprising the steps of:
connecting the mobile telecomputing device to a wireless local area network within the restaurant;
registering the mobile telecomputing device by a registration application program executed by a computer controlling the wireless local area network;
connecting the mobile telecomputing device through an Internet connection to an application server at a website providing a restaurant communication service;
presenting on a display of the mobile telecomputing device, a webpage showing a button associated with a request for service in the restaurant;
detecting that the customer pressed the button; and
routing an indication that the customer pressed the button from the application server to a communication device carried by the waiter.

13. The method according to claim 12, wherein the step of presenting the webpage on the display of the mobile telecomputing device includes presenting a webpage that shows a plurality of buttons associated with requests for a plurality of services; and
wherein the step of detecting that the customer pressed the button includes receiving an input that identifies a table number of the customer and which service was requested.

14. The method according to claim 12, wherein the waiter carries a pager and the step of routing the indication includes:
sending the indication from the server to an on-premises paging system; and
transmitting the indication by the on-premises paging system to the waiter's pager.

15. The method according to claim 12, wherein the waiter carries a mobile phone and the step of routing the indication includes:
sending the indication from the server to a public radio telecommunication network; and
transmitting the indication by the public radio telecommunication network to the waiter's mobile phone.

16. The method according to claim 15, wherein the step of transmitting the indication by the public radio telecommunication network to the waiter's mobile phone includes sending a text message to the waiter's mobile phone indicating a table number of the customer and a requested service.

17. The method according to claim 15, wherein the step of transmitting the indication by the public radio telecommunication network to the waiter's mobile phone includes sending a recorded voice message to the waiter's mobile phone indicating a table number of the customer and a requested service.

18. A system for enabling a customer with a mobile telecomputing device to communicate with a waiter in a restaurant, the system comprising:
at least one processor for controlling operation of the system;
a wireless local area network within the restaurant for communicating with the mobile telecomputing device;
a registration application program executed by a computer controlling the wireless local area network for registering the mobile telecomputing device;
an Internet connection for connecting the mobile telecomputing device to an application server at a website providing a restaurant communication service;
means for presenting on a display of the mobile telecomputing device, a webpage showing a button associated with a request for service in the restaurant;
means for detecting that the customer pressed the button; and
means for routing an indication that the customer pressed the button from the application server to a communication device carried by the waiter.

19. The system according to claim 18, wherein the waiter carries a pager and the means for routing the indication to a communication device carried by the waiter includes:
means for sending the indication from the server to an on-premises paging system; and
an on-premises paging transmitter for transmitting the indication to the waiter's pager.

20. The system according to claim 18, wherein the waiter carries a mobile phone and the means for routing the indication to a communication device carried by the waiter includes:
means for sending the indication from the server to a public radio telecommunication network; and
means for transmitting the indication by the public radio telecommunication network to the waiter's mobile phone.

21. The system according to claim 20, wherein the means for transmitting the indication by the public radio telecommunication network to the waiter's mobile phone includes means for sending a text message to the waiter's mobile phone indicating a table number of the customer and a requested service.

22. The system according to claim 20, wherein the means for transmitting the indication by the public radio telecommunication network to the waiter's mobile phone includes means for sending a recorded voice message to the waiter's mobile phone indicating a table number of the customer and a requested service.

23. A server remotely located from a business establishment for facilitating the business establishment to serve a customer, the server comprising:
a processor for controlling the operation of the server;
incoming communication means for receiving a service-request message from the customer sent via a public wireless communication network, wherein the service-request message is a text message including a business establishment identifier and a location identifier for the customer's location in an area of responsibility for the business establishment;
a first database for mapping business establishment identifiers with business establishments, wherein the server utilizes the first database to identify the business establishment;
a second database for mapping location identifiers with service personnel, wherein the server utilizes the second database to identify a service person at the identified business establishment assigned to serve the customer's location; and
outgoing communication means for notifying the identified service person that service is requested at the customer's location.

24. The server according to claim 23, wherein the server facilitates each of a plurality of business establishments serve a plurality of customers.

25. The server according to claim 23, wherein the outgoing communication means for notifying the identified service person that service is requested at the customer's location is selected from:
a public wireless network interface for sending a text or voice message to a mobile phone carried by the identified service person; and
a wide area paging network interface for sending a paging message to a pager carried by the identified service person.

26. A system for facilitating a business establishment to serve a customer, the system comprising:
a backend server comprising:
a processor for controlling the operation of the server;
incoming communication means for receiving a service-request message from the customer sent via a public wireless communication network, wherein the service-request message is a text message including a business establishment identifier and a location identifier for the customer's location in an area of responsibility for the business establishment;
a first database for mapping business establishment identifiers with business establishments, wherein the server utilizes the first database to identify the business establishment; and
outgoing communication means for sending a notification to the identified business establishment that service is requested at the received location identifier; and
a computer associated with the identified business establishment, comprising:
a processor for controlling the operation of the computer;
incoming communication means for receiving the notification from the backend server;
a second database for mapping location identifiers with service personnel, wherein the server utilizes the second database to identify a service person at the identified business establishment assigned to serve the customer's location; and
outgoing communication means for notifying the identified service person that service is requested at the customer's location.
